(19) United States
(12) Patent Application Publication
(10) Pub. No.: US 2025/0061097 A1
(43) Pub. Date: Feb. 20, 2025

(54) METHOD FOR CREATING A DATABASE FOR RECOGNIZING DRIVING CONTEXT

(71) Applicant: Continental Autonomous Mobility Germany GmbH, Ingolstadt (DE)

(72) Inventors: Harald von Rosenberg, Sigmarszell (DE); Jitendra Kumar, Bangalore (IN); Devadatta Prasad, Ballari (IN); Veena P V, Kerala (IN); Ankur Chauhan, Bangalore (IN)

(73) Assignee: Continental Autonomous Mobility Germany GmbH, Ingolstadt (DE)

(21) Appl. No.: 18/722,170

(22) PCT Filed: Dec. 1, 2022
(86) PCT No.: PCT/DE2022/200284

§ 371 Date: Jun. 20, 2024

(30) Foreign Application Priority Data
Dec. 20, 2021 (IN) 202131059254
Feb. 9, 2022 (DE) 10 2022 201 355.7

(51) Int. Cl. G06F 16/21; G07C 5/04

(52) U.S. Cl. CPC G06F 16/211; G07C 5/04

(57) ABSTRACT

A method for creating a database for driving context recognition for a driver assistance system of an ego vehicle including producing a database having sensor data based on a plurality of sensor recordings, labeling the sensor data in the database, producing dependency graphs between the labels; establishing dependencies between the labels based on the dependency graphs, identifying logical sequences of the labels, defining specific driving contexts based on the logical sequences, and saving the defined driving contexts in the database.

### CROSS-REFERENCE TO RELATED APPLICATIONS

The present application is a National Stage Application under 35 U.S.C. § 371 of International Patent Application No. PCT/DE2022/200284 filed on Dec. 1, 2022, and claims priority from Indian patent Application No. 202131059254 filed on Dec. 20, 2021, in the Indian Patent Office and German Patent Application No. 102022201355.7 filed in the German Patent and Trade Mark Office on Feb. 9, 2022, the disclosures of which are herein incorporated by reference in their entireties.

### BACKGROUND

### 1. Field

Aspects and objects of the present application relate to a method for creating a database for driving context recognition and to the use of a database in a driver assistance system.

### 2. Description of Related Art

Today's sensors and perception systems, which are used in assisted and autonomous driving systems, mainly work independently and do not build up an entire driving context of the vehicle. In connection with this, driving context means e.g., “The vehicle is driving in an urban situation in which traffic lights, stop lines and crossing pedestrians are likely and should be expected”.

There are a few context recognition features (e.g., a tunnel detection in the case of radar sensors), but these are only used for the purpose of detecting and avoiding false positives.

### SUMMARY

Thus, it is an object of the present application to propose a solution which makes driving context recognition possible.

Initial considerations were that different driving context recognition, detection and classification (e.g., detection of a “urban” vs. “country road” vs. “highway” road type) do not contain any other properties which are relevant for describing the entire scene and the entire context.

One consideration was that the dynamic dependency examines the delayed interdependencies between time series CPU & mem usage of a cloud service system using an RNN-based deep learning model. A further consideration was applying the statistical approach to a large amount of available real recording data in order to explore the dependency between different semantic designations of the scene and to deduce the driving context in comprehensive surroundings.

Furthermore, approaches which construct the scene graph in order to understand the context of the scene are known from the prior art. However, the context is more restricted to the scope of the scene capture or image capture. These approaches also utilize the spatial proximity to assign labels in order to produce the scene context. The approach used here does not use spatial proximity, but rather the behavior of the scene labels over time is examined, and the entire driving context is captured and is not only restricted to the image or scene capture.

Today's driver assistance systems have a restricted ability to detect the driving context of a vehicle. The driving functions of the assisted/autonomous driving system do not know the driving context and do not behave correctly or do not use this information.

These systems do not take account of the dependency of the different driving contexts and have problems identifying the transition points from one driving context state to another (e.g., detecting that the vehicle is leaving a city highway and directly approaching a city intersection).

Many typical false-positive detections are therefore occasioned. Examples of such false-positive detections are:
“stationary vehicles” (e.g., at a set of traffic lights or intersection) are classified as “parked vehicles” and vice versa;
expansion joints between segments of a bridge are incorrectly detected and output as obstacles (based on radar detections);
expansion joints between segments of a bridge are incorrectly detected and output as stop lines (based on an optical detection);
an inspection shaft/a manhole in the road is incorrectly detected and classified as an obstacle;
an incorrect lane model is produced in construction site sections since the construction site has not been identified.

According to the present application, a method for creating a database for driving context recognition for a driver assistance system of an ego vehicle is thus proposed, comprising the following steps of:
producing a database having sensor data based on a plurality of sensor recordings;
labeling the sensor data in the database;
producing dependency graphs between the labels;
establishing dependencies between the labels based on the dependency graphs;
identifying logical sequences of the labels;
defining specific driving contexts based on the logical sequences;
saving the defined driving contexts in the database.

The plurality of sensor recordings is preferably produced by a plurality of vehicles. It would also be conceivable for the sensor recordings to be produced by a vehicle over a specific period of time and stored in the database. However, the use of sensor data by a plurality of vehicles is advantageous due to the possible amount of different data.

In the light of this disclosure, a label describes a single, clearly characterizable observation that can be used to recognize and describe an entire context. However, a label alone does not necessarily describe a context completely and independently. Labels can also contradict one another.

The sensor data stored in the database are labeled in one step of the method. For example, the data “number of lanes”, “lane width” and the “observed direction of travel of the lanes”, which are classified accordingly, for example, by means of an algorithm, are provided in a sensor recording or in a part of the sensor recording. A “highway” label can then be produced accordingly from these classified data. Furthermore, further labels such as for example “urban”, “country road”, “bridge”, “day”, “night”, “roundabout/traffic island”, “other road users”, “weather conditions” and/or “tunnel”, etc. can be established from the data. The labels are either produced by a test driver while driving or are assigned in a post-processing step following the end of the recording.

Dependency graphs are produced regarding the labels. The dependency graphs are established by the result of a label analysis or are the result of the optimization of the labels. This analysis takes place outside the vehicle, typically during the development phase or before a software update is to be output to the vehicles. Initial connections are established between the labels by these dependency graphs. For example, the label “roundabout” can occur with the “urban” or “country road” label. By establishing the dependencies, it is ascertained in which form the labels depend on one another. For example, it is established whether a label triggers another label or always occurs together with another label, etc. A further example would be the “traffic lights” label. This label can occur on highways and in city traffic, even if the probability of a set of traffic lights in urban traffic is higher than on highways. If now, for example, a red traffic light is recognized on the highway, for example before a tunnel entrance, the context knowledge to be created can be used for the plausibility check. For example, a tunnel on the highway is firstly recognized; this would then be used as the first label “tunnel”. It is known from the dependency graph that traffic lights can exist at the tunnel entrance in the environment of tunnels on highways. After that, a set of traffic lights is recognized. This then constitutes the second label. The combination of the “tunnel” and “traffic lights” labels on a “highway” exists in the dependency graph. Consequently, a higher confidence can be assigned to the recognition of the “traffic lights” on the highway than in the case of a recognition of “traffic lights” on a highway without a tunnel connection.

Based on the dependencies, logical sequences of labels can be identified. For example, a logical sequence consisting of the “day”, “highway” and “bridge” labels could be identified. Based on this logical sequence, the driving context can be defined that the car is driving over a bridge on a highway during the day. Accordingly, a plurality of driving contexts is defined, in which different labels which have a certain dependency on one another are combined into a sequence. The defined driving contexts are then stored in a database.

In a preferred configuration, discretized time slots are in each case taken into account during the establishment of the dependencies between the labels. The discretized time slots describe fixed time intervals, e.g., 5 seconds. All of the labels which occur within a time slot are combined into a single point in time. By discretizing the time, the complexity of the problem can be reduced.

It is further preferred that the discretized time slots are analyzed and clustered. By clustering the time slots with the labels contained therein, recurring processes can be recognized or the information can be extracted that a specific label, or a group of labels, occurs after a frequently occurring time or distance at a given inherent speed of the ego vehicle v_ego. This is used to make a prediction about which labels and, therefore, which context is/are likely to follow the current labels. For example, a traffic sign which announces an exit can be defined in a simplified manner as the first label. This sign is followed at a certain distance by the exit which is defined as the second label.

A further example would be that an entrance into a tunnel, the first label, is followed by a manhole cover in the tunnel, the second label, for drainage in the tunnel even if there are no manhole covers at all outside the tunnel. It is thus advantageous in the case of this configuration that relationships are also recognized herewith, which are not immediately obvious and clear.

In a further particularly preferred configuration of the present application, the database is provided to a driver assistance system of the ego vehicle.

The database is preferably updated after providing the driver assistance system with sensor data of the ego vehicle during the operation of the ego vehicle. This is advantageous since the determination of the labels or the features which describe a label can thus, for example, be extended and updated. Furthermore, new labels can also be produced or subsequently supplemented in this way. The update can also be provided to the vehicle or the database, for example, via an over-the-air update. Furthermore, it can also be verified whether the dependencies or the sequences of labels are still applicable. A label graph analysis can be carried out when generating new labels during the operation of the vehicle. This label graph analysis can preferably be carried out during the development or during the operation of the vehicle and can in addition be used to identify circular dependencies. These circular dependencies can be used to determine which further environmental data or environmental model data are necessary in order to define a transition criterion from one label state to the next.

Furthermore, a histogram analysis is particularly preferably carried out for determining the discretized time slots. Peak clusters of the time slots can be established with the histogram analysis. With the histogram, it can be deliberately examined whether the dependencies have a fixed temporal reference, or whether they are uncoupled from the time. There are also label sequences which are significant without any special time reference between these.

### BRIEF DESCRIPTION OF THE DRAWINGS

Further advantageous configurations and embodiments are the subject-matter of the figures, in which:

FIG. 1 shows a schematic flowchart of the method according to an embodiment of the present application;

FIG. 2 shows a schematic representation of a histogram according to an embodiment of the present application;

FIG. 3 shows a schematic representation of a circular dependency according to a further embodiment of the present application.

### DETAILED DESCRIPTION OF THE EMBODIMENTS

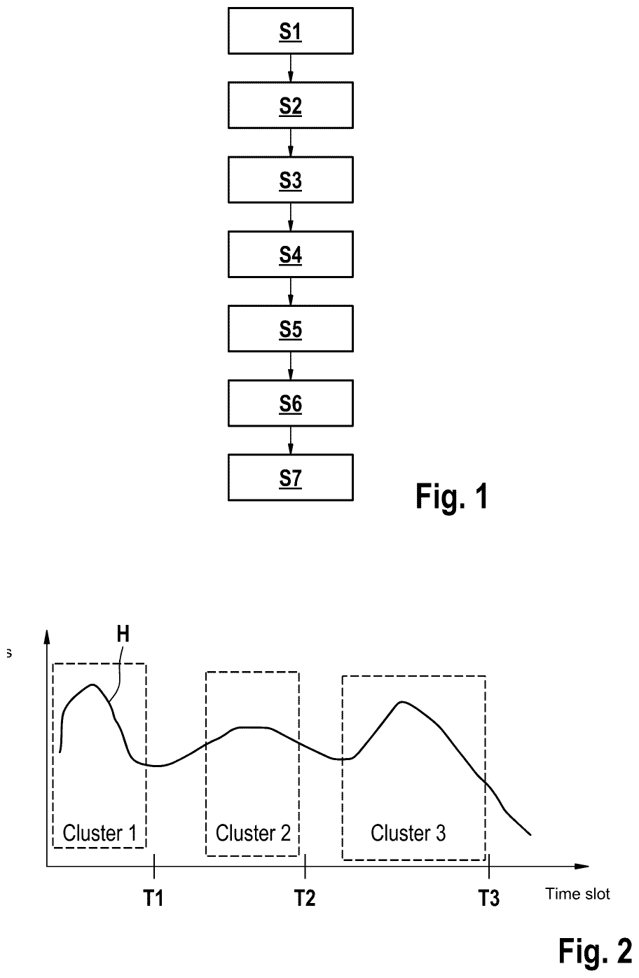

FIG. 1 shows a schematic flowchart of the method according to an embodiment of the present application. In a step S1, a database having sensor data is produced based on a plurality of sensor recordings. In a following step S2, the sensor data in the database are labeled. In step S3, dependency graphs are produced between the labels. In step S4, dependencies between the labels are established based on the dependency graphs. In a further step S5, logical sequences of the labels are identified. In step S6, driving contexts are subsequently defined based on the logical sequences. Finally, the defined driving contexts are saved in the database in a step S7.

FIG. 2 shows a schematic representation of a histogram according to an embodiment of the present application. The histogram H shows the number of occurrences of specific labels over a specific period of time. Furthermore, the time slots T1-T3 in which labels occur are indicated. The time slots T1 to T3 are clustered accordingly in cluster 1 to cluster 3.

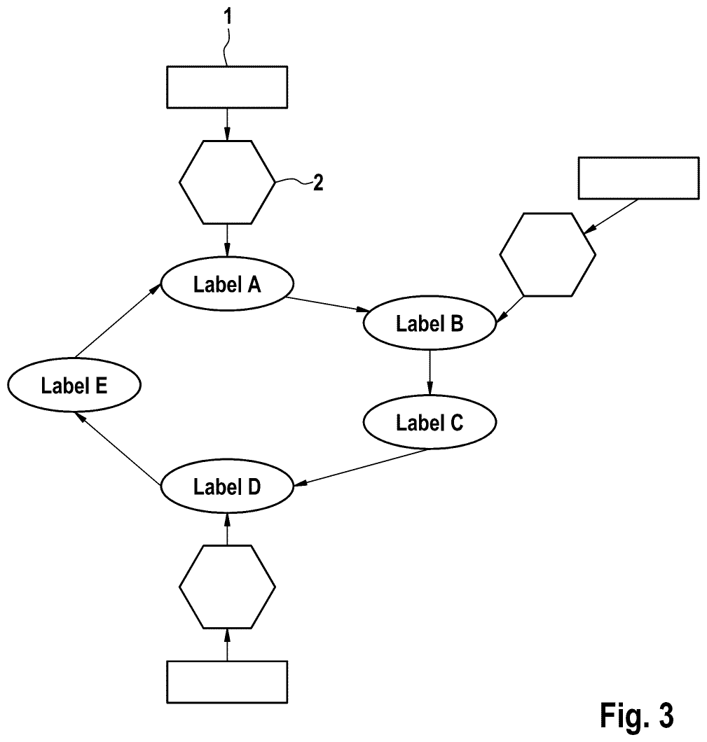

FIG. 3 shows a schematic representation of a circular dependency according to a further embodiment of the present application. A circular dependency between the labels A to E is shown in this representation. The labels C and E were already previously labeled. In order to make possible the transitions from label C to label E or label E to label C, a label generation 2 was carried out by means of environmental model data 1 and new labels were accordingly generated from the data 1. With the new environmental data 1 or the labels A, B and D produced therefrom, a circular dependency of the labels A to E can be produced. However, such analyses only take place offline. At the runtime of the method in the target vehicle, all the labels have to be recognized and identified with the available information since there is no longer any manual labeling. For each label A-E either a clear observation or environmental data 1 with label generation 2 at the runtime or the follow-up label must be available, e.g., label C after B necessarily results from the aforementioned dependency analysis, even if no explicit observation/measurement is available or possible for label C at the runtime in the vehicle.

E.g.: An icy road (=label) cannot currently be recognized in a predictive manner with the sensors used, but this can be forecast with a high degree of precision from other labels in the given context.

A further example would be that it is not possible to directly measure whether a stationary vehicle is “parked” or whether it has only “stopped” for a short time. The “parking” status is consequently a conclusion from the context. If a set of traffic lights (=label) is now recognized and at the same time a “non-moving vehicle” (label), then it is very unlikely that the vehicle has actually parked under the set of traffic lights.

1. A method of creating a database for driving context recognition for a driver assistance system of an ego vehicle, the method comprising:
producing a database having sensor data based on a plurality of sensor recordings;
labeling the sensor data in the database;
producing dependency graphs between the labels;
establishing dependencies between the labels based on the dependency graphs;
identifying logical sequences of the labels;
defining specific driving contexts based on the logical sequences; and
saving the defined driving contexts in the database.

2. The method according to claim 1, wherein the establishing comprises establishing the dependencies between the labels based on discretized time slots.

3. The method according to claim 2, wherein the discretized time slots are clustered.

4. The method according to claim 1, further comprising providing the database to a driver assistance system of the ego vehicle.

5. The method according to claim 4, further comprising updating the database with sensor data of the ego vehicle during the operation of the ego vehicle.

6. The method according to claim 2, further comprising performing a histogram analysis for determination of the discretized time slots.

7. (canceled)
